(19) United States
(12) Patent Application Publication
(10) Pub. No.: US 2007/0248007 A1
(43) Pub. Date: Oct. 25, 2007

(54) Broadband access network capacity management

(76) Inventor: Govinda N. Rajan, Huizen (NL)

Correspondence Address: CARLSON, GASKEY & OLDS, P.C., 400 W MAPLE RD, SUITE 350, BIRMINGHAM, MI, 48009, US

(21) Appl. No.: 11/410,550

(22) Filed: Apr. 25, 2006

(51) Int. Cl. H04L 12/26

(52) U.S. Cl. 370/230; 370/252; 370/468

(57) ABSTRACT

A broadband access network (20) includes a plurality of access nodes (22-28) and at least one edge node (32). The total bandwidth associated with at least a link (34) associated with the edge node (32) is divided up into independently controlled portions. A central resource database (40) in one example allocates portions of the total bandwidth exclusively among the plurality of access nodes (22-28). Flow admission is controlled at the access nodes (22-28) based upon current usage of the exclusively allocated bandwidth at each access node. In a disclosed example, the amount of the total bandwidth exclusively allocated to each access node can be changed on a periodic basis or responsive to use requirements.

### FIELD OF THE INVENTION

This invention generally relates to communications. More particularly, this invention relates to managing resources of a communication network.

### DESCRIPTION OF THE RELATED ART

Various communication networks are known. Broadband access networks include Ethernet based networks. Typical configurations include access nodes (e.g., DSLAMs) to which customer equipment may be connected. Aggregation network nodes provide an interface between the access nodes and edge nodes. The aggregation network nodes typically include many interconnected nodes that aggregate data from the access nodes to the edge nodes.

There is a significant challenge in managing use of Ethernet based networks. Providing quality of service for individual flows has been a significant challenge. Typical techniques now recognized for this purpose include Diffserv type techniques but these only provide relative quality of service. Guaranteed quality of service may be provided using path reservation techniques (e.g., MPLS, RSVP). Guaranteed quality of service using known techniques is very complex in most situations.

The common approach to managing such a network includes dividing the total bandwidth on different links into pipes such that each pipe supports a separate class of service. Scheduling packets or traffic involves each node using strict priority scheduling such that if the input at each node is not above the pre-configured limit, then each pipe is guaranteed a certain quality of service. This approach is not without problems, however.

For example, a central resource system may be used to assign bandwidth in an amount corresponding to a request for a connection through one of the access nodes to a particular edge node. The central resource system does have the capacity to reject requests that require more bandwidth than is available for the eventual connection to the edge node. It is possible, however, for a user to begin sending packets without making a request to the central resource system. This results in congestion along a link that is already carrying an amount of traffic that uses up the corresponding bandwidth. The congestion along such a link results in a lower bandwidth for all existing flows and the flow that was initiated by the user without requesting an assignment of bandwidth from the central resource system. It follows that for such an arrangement to work well, the central resource system must always be requested and connections should be used only after being allowed by the central resource system.

Even if it were possible to ensure that a central resource system as just described would always be requested to maintain control over the use of bandwidth within the network, the processing power requirements and the delay time for setting up new connections become significant drawbacks. Many access networks have a large number of customers (e.g., on the order of hundreds of thousands) and the number of connections will be extremely high. Therefore, the technique described above does not provide an efficient and manageable approach.

There is a need for better resource management and quality of service control. This invention addresses those needs.

### SUMMARY OF THE INVENTION

A method of communicating according to this invention is useful in a network having a plurality of access nodes and at least one edge node with a total bandwidth associated with at least a link to the at least one edge node.

An exemplary method includes allocating at least a portion of the total bandwidth exclusively to at least one of the plurality of access nodes. Flows at the at least one access node are allowed only if the aggregate bandwidth of allowed flows at that access node is not more than the exclusively allocated portion of the total bandwidth.

One example includes dividing the total bandwidth into a number of equal portions that equals the number of access nodes. Each of the equal portions is then allocated to one of the access nodes, respectively.

One example includes altering the portion of the total bandwidth exclusively allocated to at least one of the plurality of access nodes. In one example, the alteration occurs based upon communication between access nodes where one can request some unused bandwidth from another. In another example, a central resource database reallocates unused bandwidth from at least one access node to another access node that requires more bandwidth.

In one example, a central resource database periodically redistributes the allocation of the portions of the total bandwidth among the access nodes such that each access node has a portion of the total bandwidth allocated exclusively to it.

By refusing to admit any new flows that exceed the portion of the total bandwidth exclusively allocated to an access node, quality of service can be maintained. At the same time, the exclusive allocation technique eliminates the processing and time-consuming requirements associated with other techniques that required a request to be made to a central resource system for each new flow. Managing the admission of new flows at the access nodes provides a more efficient approach.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a communication network that is useful with an embodiment of this invention.

FIG. 2 is a flowchart diagram schematically summarizing one example approach.

### DETAILED DESCRIPTION

This invention provides a unique resource management approach that facilitates providing quality of service control within an access network. A disclosed example is based upon a principle of dividing the resources of the network into independent portions and distributing the portions to the network nodes that are closer to the customer. This approach minimizes the processing requirements and time delays otherwise associated with a central resource system and eliminates congestion that would otherwise interfere with quality of service levels within the network.

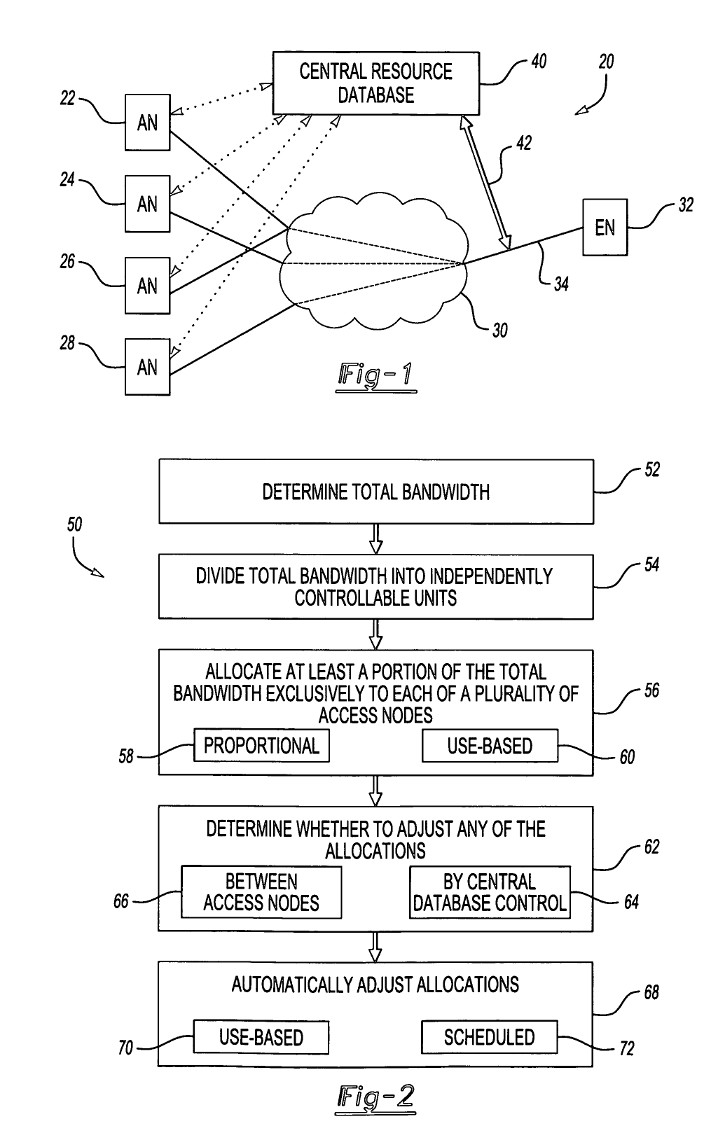

FIG. 1 schematically shows an example communication network 20. In this example, the network is a broadband access network and is Ethernet-based. A plurality of access nodes 22, 24, 26 and 28 may be connected with a customer's or user's equipment such that an individual may obtain access to the network 20 as desired. An aggregation network 30 includes a plurality of aggregation nodes that establish connection or links between the access nodes 22-28 and at least one edge node 32. In the illustrated example, there is at least one link 34 associated with the edge node 32.

The example network has a total bandwidth available for communications with the edge node 32. For purposes of discussion, the bandwidth of the link 34 is considered the total bandwidth available for communicating with the edge node 32.

A central resource database 40 comprises hardware, software or a combination of them. The central resource database 40 manages allocations of the network resources. In this example, as schematically shown at 42, the central resource database 40 obtains information regarding the total bandwidth available based upon at least the link 34. The central resource database 40 takes the total bandwidth and divides it up into fractions or portions that are treated independent of each other.

For example, the link 34 has a total bandwidth of 10 GB and the central resource database 40 divides up the 10 GB into independent portions. In one example, the central resource database 40 divides up the total bandwidth (e.g., 10 GB) into equally sized portions with a number of portions corresponding to the number of access nodes (e.g., 4) that are subject to the control of the central resource database 40. In this example, with 10 GB total bandwidth and 4 access nodes 22-28, the central resource database 40 divides up the total bandwidth into four portions each having 2.5 GB. The central resource database 40 then allocates a portion exclusively to each of the access nodes 22-28.

The exclusively allocated portion of the total bandwidth can only be used by the access node to which it is allocated. Each access node 22-28 in this example will only allow new flows provided that the aggregate bandwidth required by the flows currently at the access node does not exceed the exclusively allocated bandwidth for that access node. This provides quality of service in the network 20 by preventing any flows that would cause congestion at the link 34, for example.

Exclusively allocating the total bandwidth in independently controlled portions to the access nodes 22-28 removes the task of processing requests for bandwidth for a new flow away from the central resource database 40. This eliminates high processing requirements for new flow admission. Each access node can manage the allocated portion of the total bandwidth allocated exclusively to it without requiring high processing capability.

One example approach is summarized in the flowchart 50 of FIG. 2. In this example, the central resource database 40 determines the total bandwidth at 52. The total bandwidth is then divided into independently controllable units or portions at 54. The process at 56 includes allocating at least a portion of the total bandwidth exclusively to each of a plurality of access nodes such as the access nodes 22-28.

In one example, the allocation occurs on a proportional basis as schematically shown at 58. This would be like the example described above where the total bandwidth is divided into equally sized portions or into different sized portions with some predetermined proportional relationship between the portions. For example, some access nodes may have a history of higher use rates and, therefore, it is useful to provide more exclusively allocated bandwidth to such access nodes than others that are less busy. In examples where such information is available, a central resource database may be configured to make such a proportional allocation.

Another example technique is use-based as schematically shown at 60. In this example, the central resource database 40 determines information regarding current use at each access node and allocates the total bandwidth in corresponding amounts. One example includes considering the amount of unused bandwidth at any of the access nodes prior to a current allocation of the total bandwidth. Another example includes considering the number of flows waiting at each access node for access to the network 20.

The example of FIG. 2 includes a process at 62 for determining whether to adjust any of the current bandwidth allocations. One example is schematically shown at 64 where the central resource database 40 determines whether it would be useful or required to make any adjustment to current bandwidth allocations. Another example schematically shown at 66 includes a determination made based upon communication between the access nodes 22-28. In this example, one access node may communicate with another to request any unused bandwidth because the one access node has reached its capacity, for example. If there is unused bandwidth available at one of the access nodes, this can be used as part of the determination whether to adjust the allocations.

The example of FIG. 2 includes an automatic adjustment of the allocations at 68. As schematically shown at 70, this may be use-based. This would include situations where one or more of the access nodes has unused bandwidth capacity while one or more of the access nodes requires more bandwidth to accommodate the calls currently waiting at that access node. A use-based reallocation may occur based upon communication between the access nodes or through the central resource database 40. In examples where the access nodes are capable of reallocating bandwidth directly to each other, the central resource database 40 receives an indication of such a reallocation such that the central resource database 40 has updated information regarding current allocations. In examples where the central resource database 40 manages all allocations, it communicates with the access nodes involved in a reallocation such that unused bandwidth from one access node can be effectively taken from it and then exclusively allocated to another.

The example of FIG. 2 includes another automatic adjustment technique at 72 based upon some predetermined schedule. For example, it may be useful to periodically reallocate the total bandwidth among the access nodes to redistribute the total bandwidth among the access nodes to maintain system balance and to prevent one access node from essentially having higher priority than the others once it receives a higher allocation of the total bandwidth, for example.

While the link 34 is used for discussion purposes, any one or more links within the network 30 may be used in a control strategy as described above. Exclusively allocating portions of the available bandwidth to at least some of the access nodes in a network makes that portion of the network resources available only at the corresponding access node. Flow admission control can then be accomplished at the access node to ensure quality of service. Instead of having a central resource system coordinate the division and transmission of available resources to individual units, the disclosed example accomplishes distribution of units or portions of the available resource at the access nodes (e.g., closer to the customer or user).

The illustrated example includes a central resource database 40 that manages the allocation of the total bandwidth. Other examples include access nodes that have capabilities built in for performing the functions of the example central resource database. In one example, each access node assigns a portion of the available resource exclusively to itself based upon preconfigured limitations or current use statistics, for example. Those skilled in the art who have the benefit of this description will realize how to implement a strategy according to an embodiment of this invention using hardware, software or an appropriate combination of them to meet the needs of their particular situation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating using a network having a plurality of access nodes and at least one edge node with a total bandwidth associated with at least a link to the at least one edge node, comprising:
allocating at least a portion of the total bandwidth exclusively to at least one of the plurality of access nodes; and
allowing flows at the at least one of the plurality of access nodes such that the allowed flows have an aggregate bandwidth that is not more than the exclusively allocated portion of the total bandwidth.

2. The method of claim 1, comprising
dividing the total bandwidth into independently controllable portions; and
allocating the portions exclusively to the plurality of access nodes such that all of the total bandwidth is allocated.

3. The method of claim 2, comprising
dividing the total bandwidth into a number of equal portions that equals the number of the plurality of access nodes; and
allocating each of the equal portions to one of the plurality of access nodes, respectively.

4. The method of claim 1, comprising
altering the portion of the total bandwidth exclusively allocated to the at least one of the plurality of access nodes.

5. The method of claim 4, comprising at least one of
periodically altering the portion according to a predetermined schedule;
altering the portion responsive to a need for additional bandwidth at the at least one of the plurality of access nodes; or
altering the portion responsive to a need for additional bandwidth at another one of the plurality of access nodes.

6. The method of claim 4, comprising
increasing the portion allocated to the at least one of the plurality of access nodes; and
decreasing a portion allocated to at least one other of the plurality of access nodes.

7. The method of claim 4, comprising
communicating a request for an additional amount of the total bandwidth from the at least one of the plurality of access nodes to at least one other of the plurality of access nodes; and
responding to the request by surrendering an unused amount of the total bandwidth from the at least one other of the plurality of access nodes to the at least one of the plurality of access nodes.

8. The method of claim 4, comprising
periodically surrendering an unused amount of bandwidth currently allocated to any of the plurality of access nodes; and
allocating the surrendered unused amount of bandwidth to at least one of the plurality of access nodes.

9. The method of claim 4; comprising
determining an amount of use at each of the access nodes; and
redistributing the total bandwidth among the plurality of access nodes in respective amounts corresponding to respective amounts of use at each of the access nodes.

10. The method of claim 1, comprising
determining an expected use of bandwidth at the at least one of the plurality of access nodes; and
allocating the portion of the total bandwidth in an amount corresponding to the determined expected use.

11. The method of claim 1, comprising
determining an amount of bandwidth associated with currently requested flows at the at least one of the plurality of access nodes; and
allocating the portion of the total bandwidth in an amount corresponding to the determined amount.

12. A communication system, comprising:
at least one edge node;
a plurality of access nodes; and
at least one link associated with the edge node for communicating with the plurality of access nodes, the at least one link having a total bandwidth, at least one of the plurality of access nodes having a portion of the total bandwidth allocated exclusively to the at least one of the plurality of access nodes and allowing flows at the at least one of the plurality of access nodes in an amount not more than the exclusively allocated portion of the total bandwidth.

13. The system of claim 12, comprising
a central resource database that allocates portions of the total bandwidth exclusively to respective ones of the plurality of access nodes.

14. The system of claim 13, wherein the central resource database redistributes the total bandwidth among at least some of the plurality of access nodes.

15. The system of claim 14, wherein the central resource database periodically requests that any unused bandwidth at any of the plurality of access nodes be surrendered and the central resource database allocates any surrendered bandwidth to at least one of the plurality of access nodes.

16. The system of claim 14, wherein the central resource database determines that at least one of the plurality of access nodes requires additional bandwidth and responsively allocates some of the bandwidth previously allocated to another of the plurality of access nodes to the at least one of the access nodes.

17. The system of claim 12, wherein the plurality of access nodes communicate with each other and at least one of the access nodes requests some of the bandwidth allocated to another of the access nodes and wherein at least one other of the access nodes surrenders an unused portion of allocated bandwidth to the at least one of the access nodes.

18. The system of claim 12, wherein the total bandwidth is divided into independently controllable portions and each of the access nodes has at least one of the portions exclusively allocated portion such that the total bandwidth is allocated among the plurality of access nodes.

19. The system of claim 12, wherein the total bandwidth is distributed among the plurality of access nodes in equal portions, respectively.

20. The system of claim 12, wherein the total bandwidth is distributed among the plurality of access nodes responsive to an amount of bandwidth use at each of the access nodes, respectively.
